(19) United States
(12) Patent Application Publication
(10) Pub. No.: US 2005/0181330 A1
(43) Pub. Date: Aug. 18, 2005

(54) Abutment of dental implant and aesthetic surface treatment method of the same

(76) Inventors: Soo Hong Kim, Busan (KR); Yoon Bok Lee, Busan (KR)

Correspondence Address: PARK & SUTTON LLP, 3255 WILSHIRE BLVD, SUITE 1110, LOS ANGELES, CA, 90010, US

(21) Appl. No.: 10/919,173

(22) Filed: Aug. 16, 2004

(30) Foreign Application Priority Data
Feb. 17, 2004 (KR) 10-2004-0010308

(51) Int. Cl. A61C 8/00

(52) U.S. Cl. 433/173

(57) ABSTRACT

The present invention discloses an abutment of a dental implant consisting of an abutment screw and a shoulder surface. The upper structure of a crown or bridge abutment, i.e., the abutment screw is made of titanium alloy, and surface-treated in brown color by an anodizing process, and the connecting structure thereof, i.e., the shoulder surface is made of ceramic material containing zirconia of a white color, thereby providing an adequate mechanical strength, while maintaining the natural color of human teeth and light permeability. Further, the present invention discloses a method of aesthetically surface-treating the abutment screw of a dental implant abutment by using the anodizing process, and a method of fabricating the shoulder surface of a dental implant abutment.

### CLAIMING FOREIGN PRIORITY

The applicant claims and requests a foreign priority, through the Paris Convention for the Protection of Industry Property, based on a patent application filed in the Republic of Korea (South Korea) with the filing date of Feb. 17, 2004, with the patent application number 10-2004-0010308, by the applicant. (See the attached Declaration)

### BACKGROUND OF THE INVENTION

The invention relates generally to a massaging device. More particularly, the present invention relates to an improved lie-down massager capable of efficiently treating bodily malfunctions such as back pain and gastrointestinal weakness by applying a therapeutic massaging treatment along the back and neck of a patient lying down on the massager whose massaging bumps move horizontally and vertically along the patient's spinal cord and neck while the vertical movement of the massaging bumps are compensated and smoothed by air shock actuators.

Conventional bed or mat type massaging devices employ a spring mechanism for vertically moving massaging bumps. As disclosed U.S. Pat. No. 6,454,732, a spring mechanism allows the massaging bumps to gently move up and down. However, when it comes to therapeutic effects, the spring mechanism proves too soft to push up the massaging bumps when stronger pressure is required, because tension of springs applies equally to patients lying on the massaging device regardless of patient's requirements.

The present invention relates to an abutment of a dental implant and a method of aesthetically treating the surface thereof. Particularly, the invention relates to such an abutment and method, in which the upper structure of a crown or bridge abutment in the dental implant, i.e., an abutment screw is made of titanium alloy, and surface-treated in brown color by an anodizing process, and the connecting structure thereof, i.e., a shoulder surface, is made of ceramic material containing white zirconia, thereby providing an adequate mechanical strength, while maintaining the natural color of human teeth and light permeability.

Recently, it has been found that titanium can serve as the root of a tooth by bonding with a jawbone without giving any detrimental effect to the human body. Therefore, titanium is extensively utilized as a material for artificial teeth. The dental implant, which serves as the root of an artificial tooth, is planted into the jawbone and is used as a substitute for a root of the human teeth, and thus a number of attempts have been made in order to improve its bondability with the human bones through various surface-treatment. However, considering aesthetic appearance of the artificial teeth, a research on the surface-treatment for providing the natural color of human teeth has not intensively been conducted.

For exapple, Korean Patent Laid-Open Publication No. 1996-0010743 discloses a hybrid implant material and manufacturing method thereof, Korean Patent Laid-Open No. 10-0292621 discloses a method of surface-treating an implant, Korean Patent Laid-Open Publication No. 2003-0031664 discloses a method of electrochemically surface-treating an implant made of titanium or titanium alloy, and U.S. Pat. No. 6,454,569 discloses a dental implant having a bio-compatible color. These inventions, however, are not directed to the surface-treatment techniques for aesthetically improving a color tone of the dental implants, but techniques for enhancing the bondability and bio-stability between the implant and the human bone.

In addition, U.S. Pat. Nos. 5,478,237 and 5,354,390, Japanese Patent Laid-Open Publication Nos. Hei 9-051940 and 11 -009679 disclose methods of surface-treating a dental implant made by titanium materials by anodizing. Similarly, these patents are for enhancing the bondability and bio-stability, but not for improving the colors of the implants.

In general, the natural color of teeth is milky-white, but may become darkish due to an internal change in the structure, or change to a yellowish color due to external influences such as smoking and drinking. Accordingly, when an implant made of bio-titanium or its alloys is implanted, a problem occurs in that, as time passes, the dark color of the titanium material may penetrate into the teeth and the gum, thereby spoiling the appearance of the teeth.

Therefore, in order to solve the above problem occurring in the prior art, an artificial tooth having a light ash color has been proposed. FIG. 1 shows the cross-section of a conventional bridge-implant, and FIG. 2 shows the cross-section of a conventional crown-implant. As shown in FIGS. 1 and 2, the conventional dental implant generally includes a fixture 550 and 650 to be planted in the human jawbone, and an abutment 520 and 620 to be engaged with an artificial tooth 510, 610. The abutment includes an abutment screw 530 and 630 to be engaged with the artificial tooth 510 and 610, and a shoulder surface 540 and 640 to be buried in the gum. In the case of the bridge type, the shoulder surface 540 is planted to the gum in its entirety, but in the case of the shoulder surface 640 of the crown-type, its lower portion is buried into the gum and its upper portion is engaged with the artificial tooth. In the lower central portion of the artificial tooth is formed a conical hole slightly slanted upwardly and inwardly, in which the upper projection of the abutment screw 530, 630 is inserted to be engaged with the artificial tooth 510, 610. Considering the aesthetic appearance of the artificial tooth, the inner surface of the conical hole, with which the abutment screw 530, 630 is engaged, is sintered to have a brown color by using a separate ceramic material, in order to provide the natural color of human teeth. In the above-described conventional technique, however, due to their different colors, the composition of ceramic materials constituting the inner surface of the hole must be different from that of the remaining portion of the artificial tooth. Therefore, this conventional technique results in a complexity of the fabricating process. Furthermore, the darkish color is smeared into the gum from the lower structure of the abutment, i.e., the shoulder surface buried in the gum, thereby failing to provide a decent appearance.

An example of a patent devised considering the aesthetic appearance of artificial teeth includes Japanese Patent Laid-Open Publication No. Hei 6-78935 which discloses ceramic-sintered dental prosthesis composed of Al₂O₃, MgO and SiO₂ and having an opal color similar to the natural tooth color. This patent is directed to a dental prosthesis, but not a dental implant. The composition of the ceramic materials and the sintering condition cannot be readily controlled in order to obtain a desired color, and furthermore, if the sintering conditions are not appropriate, the strength of the sintered dental prosthesis is rather inadequate, in contrast to the conventional titanium implant.

As an approach to solve the above problem, the inventor had found that, when an implant made of a pure titanium or titanium alloy is surface-treated by the anodizing process, various colors can be developed, depending on the voltage caused by the current applied to the electrolytic bath and the thickness of the oxidation film formed. Korean Patent Laid-Open Publication No. 2003-0062396, which has been filed by the inventor on Sept. 6, 2003, discloses the above findings, i.e., a technology for manufacturing an implant having a light ash color, which is most suitable for the human teeth of milky white color. It is, however, found that the above invention is suitable only to those having a light ash colored teeth, but not to yellowish teeth for some reasons.

Therefore, as the result of various efforts to solve the above problems, the inventor has discovered that when an abutment screw (i.e., the upper structure of an implant abutment) is made of titanium alloy, but not a pure titanium, and surface-treated in a brown color by using the anodizing process, and a shoulder surface (i.e., the connecting structure thereof) is made of ceramic material containing zirconia of a white color, the abutment produced has an adequate mechanical strength, simultaneously while maintaining the natural color of teeth and light permeability.

### SUMMARY OF THE INVENTION

Therefore, the present invention has been made in view of the above problems occurring in the prior art, and it is an object of the present invention to provide the upper structure of implant abutment, i.e., the abutment screw made of titanium alloy and a method of aesthetically surface-treating the same, wherein the surface of the abutment screw is anodized using a solvent of metallic ion at a high-voltage within a short period of time in order to form an oxide film of titanium ceramic having a bright brown color similar to the natural color of yellowish human teeth.

Another object of the invention is to provide an abutment screw of a dental implant abutment made of titanium alloy and a method of aesthetically surface-treating the same, wherein a porous oxide film of titanium ceramic formed on its surface has no crack on the surface thereof, and provides for an excellent initial adaptability to human tissue, together with a good bio-compatibility with human body.

A further object of the invention is to provide the connecting structure of a dental implant abutment, i.e., a shoulder surface made of a ceramic material containing white zirconia, in which the shoulder surface has a natural human gum color.

To accomplish the above objects, according to one aspect of the invention, there is provided an abutment of a dental implant. The abutment of the invention comprises: a) an abutment screw for being engaged with an artificial tooth, wherein the abutment screw is made of a titanium alloy and surface-treated in a brown color by means of anodizing; and b) a shoulder surface for being planted into a gum, wherein the shoulder surface is made of a ceramic material containing zirconia.

Preferably, the titanium alloy includes a Ti-6Al-4V series alloy and the ceramic material contains more than 90 wt % of zirconia.

According to another aspect of the invention, there is also provided a method of aesthetically surface-treating an abutment screw of a dental implant abutment. The method of the invention comprises steps of: a) pre-treating the abutment screw, wherein the abutment screw is supersonic-cleaned for 10 minutes using tri-chloroethane solution having a high purity of above 90% to remove contaminants from the surface thereof, supersonic-cleaned using normal hexane solution having a purity of 95% to remove grease from the surface thereof, and is dried; b) preparing an electrolyte, wherein a 95% sulfuric acid solution and a 85% phosphoric acid solution are mixed at the ratio of 5:1 to make a 0.5 mol solution, and 2 ml of 2% oxygenated water is added to 1 liter of the 0.5 mol solution to make the electrolyte; c) anodizing the abutment screw using an electrolytic bath containing 400 ml of the prepared electrolyte, wherein a titanium alloy rod is connected to the cathode of the electrolytic bath, the abutment screw is connected to the anode of the electrolytic bath, the distance between the electrodes is held to 5 cm, and a current having a density of 1.5 A/dm² is applied to the electrodes until the voltage reaches 240 V; and d) post-treating the anodized abutment screw to remove electrolyte remaining on an oxide film formed on the surface of the abutment screw, wherein the anodized abutment screw is supersonic-cleaned for 10 minutes using an ethanol solution, and supersonic-cleaned using distilled water; e) wherein the oxide film formed on the surface of the abutment screw has a bright brown color similar to the natural color of yellowish humane teeth.

Preferably, the titanium alloy rod includes a Ti-6Al-4V series alloy containing 90 wt % of titanium, 6 wt % of aluminum and 4 wt % of vanadium.

According to one embodiment of the invention, the anodizing step describe above includes the steps of adjusting the rectifier voltage to 240 V, connecting a titanium alloy rod to the cathode of the electrolytic bath and the abutment screw to the anode of the electrolytic bath, respectively, to hold the distance between the electrodes to 5 cm, and applying a current having a density of 1.5 A/dm², thereby forming an oxide film having a bright brown color.

According to another aspect of the invention, there is provided a method of aesthetically surface-treating a shoulder surface of a dental implant abutment. The method of the invention comprises steps of: a) pressure-compacting a ceramic material containing more than 90.0 wt % of zirconia of fine particles having white color inside a metal mould; and b) sintering the compacted material at 1,400-1,500° C.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 shows the cross-section of a conventional bridge-implant;

FIG. 2 shows the cross-section of a conventional crown-implant;

FIG. 3a illustrates the growth of oxide film caused by a diffusion of oxygen through the titanium and titanium oxide layer;

FIG. 3b shows a relationship of applied voltage with the thickness of oxide film due to a voltage drop by the high electrical resistance of the oxide layer (film);

FIG. 3c shows a voltage and current variation with time;

FIG. 4 illustrates a cross-section of the bridge implant abutment according to the invention; and

FIG. 5 shows a cross-section of the crown implant abutment according to the invention.

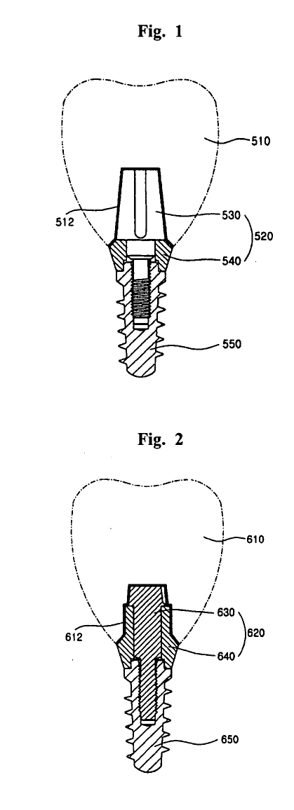

### DETAILED DESCRIPTION OF THE PREFERRED EMBODIMENT

Reference will now made in detail to the preferred embodiment of the present invention with reference to the attached drawings.

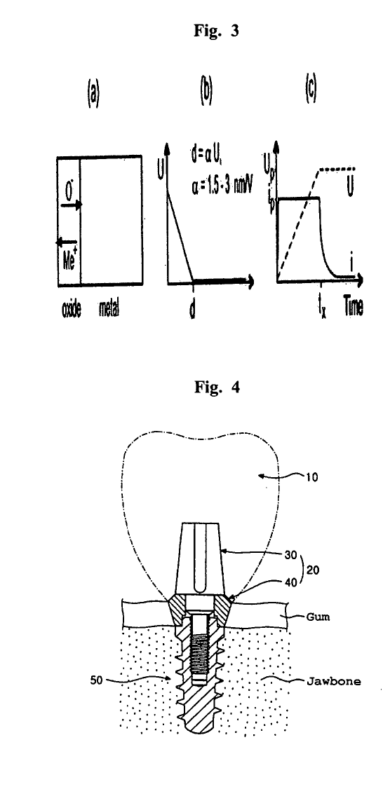

The present invention relates to an aesthetic surface treatment of an abutment screw, which is the upper structure of a dental implant. In the surface treatment according to the invention, the thickness of oxide film and the surface morphology are affected by a formation voltage caused by the applied current and the condition of electrolyte. FIG. 3 illustrates a progress of oxidation during the anodizing process according to one embodiment of the invention. FIG. 3a illustrates the growth of oxide film caused by a diffusion of oxygen through the titanium and titanium oxide layer. FIG. 3b shows a relationship of applied voltage with the thickness of oxide film due to a voltage drop by the high electrical resistance of the oxide layer (film). FIG. 3c shows a voltage and current variation with time. Since the oxide film has a relatively high electrical resistance, as compared with electrolyte and titanium alloys, the applied voltage drops during the course of the formation of oxide film. However, if a sufficient electric field is applied to the oxide layer, electric current can flow the oxide layer due to the movement of ion therethrough, and the oxide film can continue to grow. In this case, the final thickness (D) of the oxide film is determined by the following equation (1), regardless of the type of electrolyte.
D=a U (a: a coefficient of growth rate in the range of 1.5-3 nm/V)

The above relationship is true only below the limit of dielectric breakdown. It is around 100V and varies slight with the electrolyte and the condition of reaction. The anodizing process is carried out under the condition of constant current or voltage. In the process of FIG. 3b, the voltage remains constant, which means that the current can be controlled until the constant voltage is reached as the current drops. If the anodizing is carried out above the limit of dielectric breakdown, the oxide film does not block the current flow and continues to grow. This is, at a high voltage, the emission of gas is increased and a spark is generated. This type of anodizing is called a spark anodizing. The spark anodizing forms rather rough and porous oxide film, in contrast with below the limit of dielectric breakdown. In other words, at a low voltage, a barrier layer is formed, and, as the voltage increases, a spark begins to occur due to dielectric breakdown. Consequently, on the surface of the oxide layer is formed a rough and porous oxide film, which has a good bondability and bio-stability.

According to the aesthetic surface treatment of the abutment screw of the implant abutment of the invention, a fine portion of the abutment screw can be treated and formed of an oxide film by using the anodizing process. In addition, the titanium oxide film is formed by using a solvent of titanium metallic ion at a high voltage within a short period of time, thereby being able to develop an inherent bright brown color of titanium oxide, and also to apply the invention regardless of the shape and size of the abutment screw.

The shoulder surface of the dental implant abutment according to the invention is composed of a ceramic material containing more than 90.0 wt % of high-purity fine particle Zirconia having a white color. That is, the shoulder surface of the invention is fabricated in such a way that the fine powder of raw material is shaped under a high-pressure inside a metal mould and sintered at 1,400 to 1,500° C. Therefore, the produced shoulder surface has the natural color of human gum and an adequate mechanical strength. The shoulder surface made of zirconia ceramic material has an apparent specific gravity of 5.7 g/cm³, an absorption rate of 0.6, and a compression strength of above 400 MPa, i.e., a high mechanical strength and fracture toughness is achieved.

The chemical composition of the zirconia ceramic materials is shown in the following table 1.

TABLE 1

| Composition | Weight Percent |
|---|---|
| ZrO₂(HfO₂) | 94.4 |
| YO₂O₃ | 5.2 |
| SiO₂ | — |
| Al₂O₃ | 0.1 |
| Fe₂O₃ | — |
| H₂O | 0.1 |
| Ignition Loss | 0.2 |

In the crown abutment and bridge abutment of the dental implant according to the invention, the upper structure of the abutment, i.e., the abutment screw to be engaged with an artificial tooth is made of a titanium alloy (Ti-6Al-4V) and surface-treated in a brown color by anodizing. The shoulder surface to be planted into the gum is made of ceramic materials containing zirconia.

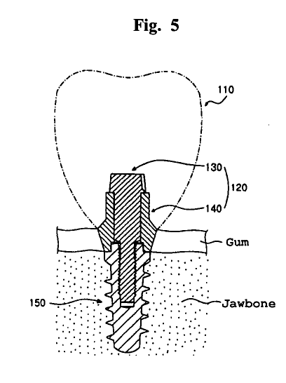

The abutment of a dental implant according to the invention will be hereafter described in greater detail, in conjunction with FIGS. 4 and 5.

FIGS. 4 and 5 illustrate a cross-section of the bridge and crown abutment of a dental implant according to one embodiment of the invention. The dental implant of the invention is generally comprised of an abutment 20, 120 supporting an artificial tooth 10, 110 and a fixture 50, 150 being implanted to the jawbone, and categorized into a bridge implant and a crown implant, depending on the structure of the abutment.

FIG. 4 illustrates a cross-section of the bridge implant abutment according to the invention. The abutment screw 30 to be engaged with the artificial tooth 10 of the abutment 20 is made of a titanium alloy (Ti-6Al-4V) and surface-treated by anodizing in a brown color, and the shoulder surface 40 to be planted into the gum is made of ceramic materials containing zirconia.

FIG. 5 shows a cross-section of the crown implant abutment according to the invention. Dissimilar to the shoulder surface 40 of the above bridge implant abutment, the upper portion of the shoulder surface 140 of the crown implant abutment is engaged with the artificial tooth 110, and the lower portion thereof is planted into the gum. Similarly, the shoulder surface 140 of the crown implant abutment is made of ceramic materials containing zirconia.

The abutment screw 30, 130 of the above bride and crown implant abutment both is made of a titanium alloy (Ti-6Al-4V) and surface-treated in a brown color by anodizing, thereby maintaining the natural color of human teeth. Also, the shoulder surface 40, 140 is made of ceramic materials containing zirconia. Therefore, in the case of the bridge type, the natural color of the gum can be developed, and in the case of the crown type, it can provide the artificial tooth 110 with the natural color of human teeth, as well as the natural gum color.

The present invention will be further explained with reference to the following Examples.

The invention is, however, not limited to the examples.

A. Anodizing of Abutment Screw

a) Anodizing Experiment

i) Preparation of Test Specimen

As a specimen for the titanium alloy abutment screw (upper structure) of implant abutment, a titanium alloy plate (Ti-6Al-4V) was cut into a size of 20×5×5 mm. Contaminant on the surface of the specimen was removed and then the surface was polished with sandpaper of #400 and #800 in order to adjust the surface roughness. After polishing, the specimen was supersonic-cleaned with acetone solution for 10 minutes, washed adequately with distilled water, dried and held in a desiccator

The titanium alloy contains 90 wt % of titanium, 6 wt % of aluminum, and 4 wt % of Vanadium.

ii) Anodizing Experiment

### EXAMPLE

In order to make an electrolyte to be used for forming oxide film on the surface of the titanium alloy specimen, 95% sulfuric acid and 85% phosphoric acid were mixed at the ratio of 5:1 to make a 0.5 mol mixed solution, and 2 ml of 2% oxygenated water was added to 1 liter of the 0.5 mol mixed solution to prepare the electrolyte. Then, an electrolytic bath containing 400 ml of the electrolyte was prepared. A titanium alloy rod was connected to the cathode of the electrolytic bath, the prepared titanium alloy specimen was connected to the anode of the bath, and the distance between the electrodes was fixed to 5 cm. If the rectifier voltage for the electrolytic bath is adjusted to 240 V and a constant current of 1.5 A/dm² density is applied, then an oxide film is formed on the surface of the titanium alloy specimen. The temperature of the electrolytic bath was 20° C.

As the titanium alloy rod connected to the cathode, the Ti-6Al-4V alloy was employed.

### COMPARATIVE EXAMPLE

Except that a pure titanium rod was employed instead of the titanium alloy rod, and the current density was adjusted to 0.5 A/dm² the remaining procedures were the same as in the above example.

b) Measurement

With respect to each oxide film formed according to the Example and Comparative example, a maximum surface roughness and an average surface roughness(Ra) were measured using a surface roughness tester.

c) Result

i) Formation of Oxide Film under Constant Current

The results of the Example and Comparative Example are summarized in the following table 2. As shown in the table 2, the color tone of the oxide film formed on the surface of the titanium alloy specimen was found to be a bright brown similar to the natural color of yellowish human teeth in the case of the example, and in the case of the Comparative Example, found to be gray, different from the milky white color of natural human tooth. As understood from the table 2, it had been found that the color of the oxide film formed on the surface of titanium materials varies with the kind of titanium material, the composition of electrolyte, and the current density.

TABLE 2

| | Composition of | | | | |
|---|---|---|---|---|---|
| | electrolyte | | | | |
| | | 2% oxy- | | | |
| | Mixed | genated | | Electrolytic | Color of |
| | Solution¹⁾ | water | Material | Condition | Film |
| Example | 1 l | 2 ml | Ti Alloy | 1.5 A/240 V | Bright |
| | | | | | Brown |
| Comparative | 1 l | 2 ml | Ti | 0.5 A/240 V | Gray |
| Example | | | | | |

Note
¹⁾0.5 mol mixed solution of 95% sulfuric acid and 85% phosphoric acid at the ratio of 5:1

ii) Surface Morphology of Specimen

In the anodizing process where a rough porous oxide film was formed in the surface of titanium alloys by spark discharge, the thickness and surface morphology of the formed oxide film was affected by the electrolytic condition and the voltage established by the applied current. The crystal structure of the formed oxide film and its thickness varies, depending on the electrolyte and the formation voltage. It could be, therefore, expected that the initial adjustment with tissue would be improved through the anodizing, along with the inherent bio-compatibility and bio-affinity of titanium. In order to determine an optimal condition for obtaining a surface structure having a good bondability with human bones, the present invention has attempted various anodizing experiments under constant current. More specifically, the thickness of oxide film was increased, and the surface roughness and porosity of oxide film were varied in many ways.

Under the constant current at the range of 0.5-1.5 A/dm², the voltage was increased over time while generating spark, and reached around 240 V and then remained constant. The reason for this is that the growth of oxide film slowed down or stopped due to the spark caused by dielectric breakdown in the surface region of the barrier layer. Therefore, the surface morphology of the formed oxide film was varied, depending on the variation in the current density. As described above, according to the process of the growth of oxide film in the anodizing process, first a very dense oxide film was formed on the metallic surface. Then, as the time passes, this initial oxide film was developed to a barrier layer, which hindered the flow of electric current. Thereafter, as the voltage increases, the barrier layer continued to grow while producing a porous surface layer. During the process where the dense oxide film initially formed was destroyed and restored due to the spark discharge, the initial oxide film was locally heated and melted on its surface and, after the barrier layer, enormous pores were formed, which was considered to be the result of spark discharge. During this course of process, the whole thickness of the oxide film was increased, and negative ions in the electrolyte was intermixed into the oxide film by means of the applied electric field.

iii) Surface Roughness of Specimen

The surface roughness values before and after alumina grids blasting of the anodized specimen are summarized in the table 3. The surface roughness of the specimen before anodizing was 0.35 μm. After anodizing, the specimen of the example and Comparative Example had a surface roughness of 0.84 μm-1.05 μm. By the alumina grids blasting, the surface roughness of the specimen was increased by around 20-30%. It is therefore understood that the alumina grids blasting affect the surface roughness.

TABLE 3
Surface Roughness (Ra) of Anodized Specimen

| | | | After Alumina Grids | |
|---|---|---|---|---|
| Before Alumina Grids Blasting | | | Blasting | |
| | | Comparative | | Comparative |
| Before Testing | Example | Example | Example | Example |
| — | 1.5 A | 0.5 A | 1.5 A | 0.5 A |
| 0.35 μm | 1.05 μm | 0.84 μm | 1.21 μm | 0.98 μm |

As understood from the above test result, the anodized abutment screw of a dental implant had a bright brown color which was similar to the natural color of yellowish human teeth, and had a slightly roughened surface.

B. Fabrication of Shoulder Surface

### EXAMPLE

a) Fabrication of Abutment Using Zirconia Ceramic Material

A material containing more than 90 wt % of zirconia was shaped under high-pressure using a metal mold and sintered using an electric furnace at 1,400-1,500° C. to fabricate a ceramic abutment.

b) Property of Ceramic Abutment

The mechanical property of the fabricated ceramic abutment is shown in the table 4. The apparent specific gravity is 5.7 g/cm³, which is near the theoretical density (5.71 g/cm³). It was found to be a very dense structure having a porosity rate of 3.2 % and an absorption rate of 0.6. Furthermore, the fabricated abutment had a very high value of compression and bending strength of 425 MPa and 19.1 MPa respectively at a room temperature (25° C.). After testing the compression strength, the ceramic abutment showed a high mechanical strength and fracture toughness, and therefore, found to be suitable for a ceramic abutment for an artificial tooth.

TABLE 4

| Mechanical Property | Test Result |
|---|---|
| Apparent Specific Gravity (g/cm³) | 5.7 |
| Apparent Porosity Rate (%) | 3.2 |
| Absorption Rate (%) | 0.6 |
| RT Compression Strength (MPa) | 425 |
| RT Bending Strength (MPa) | 19.1 |

c) Property Test of Zirconia Ceramic Abutment

i) Apparent Specific Gravity, Apparent Porosity Rate, and Absorption Rate

The test method of apparent specific gravity, apparent porosity rate and absorption rate follows KS L ISO 18754 (Fine Ceramics and Test Method of Density and Apparent Porosity Rate) and KS L 3114 (Test Method of Apparent Porosity Rate, Absorption Rate and Specific Gravity of Heat-resistant Brick).

ii) Compression Strength at Room Temperature

The test method of compression strength at room temperature followed KS L 1601 (Test Method of RT Compression Strength of Monolith Ceramic).

iii) Bending Strength at Room Temperature

The test method of RT bending strength followed KS L 1591 (Fine Ceramics and Test Method of RT Bending Strength of Monolith Ceramic).

According to the present invention, the upper structure of implant abutment, i.e., the abutment screw is made of titanium alloy. The surface of the abutment screw is anodized using a solvent of metallic ion at a high-voltage within a short period of time such that a porous oxide film of titanium ceramic can be formed thereon. The formed porous oxide film has a bright brown color similar to the natural color of yellowish human teeth, and has no crack on the surface thereof. Furthermore, the porous oxide film of the invention provides for an excellent initial adjustment to human tissue, together with a good bio-compatibility with human body.

In addition, the shoulder surface of a dental implant abutment of the invention is made of a ceramic material containing white zirconia, and advantageously has a natural human gum color.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An abutment of a dental implant comprising:
a) an abutment screw for being engaged with an artificial tooth, wherein the abutment screw is made of a titanium alloy and surface-treated in a brown color by means of anodizing; and
b) a shoulder surface for being planted into a gum, wherein the shoulder surface is made of a ceramic material containing zirconia.

2. An abutment of a dental implant according to claim 1, wherein the titanium alloy includes a Ti-6Al-4V series alloy.

3. An abutment of a dental implant according to claim 1, wherein the ceramic material contains more than 90 wt % of zirconia.

4. A method of aesthetically surface-treating an abutment screw of a dental implant abutment, the method comprising the steps of:
a) pre-treating the abutment screw, wherein the abutment screw is supersonic-cleaned for 10 minutes using tri-chloroethane solution having a high purity of above 90% to remove contaminants from the surface thereof, supersonic-cleaned using normal hexane solution having a purity of 95% to remove grease from the surface thereof, and is dried;
b) preparing an electrolyte, wherein a 95% sulfuric acid solution and a 85% phosphoric acid solution are mixed at the ratio of 5:1 to make a 0.5 mol solution, and 2 ml of 2% oxygenated water is added to 1 liter of the 0.5 mol solution to make the electrolyte;
c) anodizing the abutment screw using an electrolytic bath containing 400 ml of the prepared electrolyte, wherein a titanium alloy rod is connected to the cathode of the electrolytic bath, the abutment screw is connected to the anode of the electrolytic bath, the distance between the electrodes is held to 5 cm, and a current having a density of 1.5 A/dm² is applied to the electrodes until the voltage reaches 240 V; and
d) post-treating the anodized abutment screw to remove electrolyte remaining on an oxide film formed on the surface of the abutment screw, wherein the anodized abutment screw is supersonic-cleaned for 10 minutes using an ethanol solution, and supersonic-cleaned using distilled water;
e) wherein the oxide film formed on the surface of the abutment screw has a bright brown color similar to the natural color of yellowish humane teeth.

5. A method according to claim 4, wherein the titanium alloy rod includes a Ti-6Al-4V series alloy containing 90 wt % of titanium, 6 wt % of aluminum and 4 wt % of vanadium.

6. A method according to claim 4, wherein the anodizing step includes the steps of:
adjusting the rectifier voltage to 240 V, connecting a titanium alloy rod to the cathode of the electrolytic bath and the abutment screw to the anode of the electrolytic bath, respectively, to hold the distance between the electrodes to 5 cm, and applying a current having a density of 1.5 A/dm² to the cathode and the anode of the electrolytic bath thereby forming an oxide film having a bright brown color.

7. A method of fabricating a shoulder surface of a dental implant abutment, the method comprising steps of:
a) pressure-compacting a ceramic material containing more than 90.0 wt % of zirconia of fine particles having white color inside a metal mould; and
b) sintering the compacted material at 1,400-1,500° C.
